(19) United States
(12) Patent Application Publication
(10) Pub. No.: US 2026/0367647 A1
(43) Pub. Date: Nov. 19, 2026

(54) CONVEYANCE SYSTEM, CONVEYANCE METHOD, AND CONVEYANCE VEHICLE FOR USE IN CONVEYANCE SYSTEM

(71) Applicant: Mitsubishi Electric Corporation, Tokyo (JP)

(72) Inventors: Yuta WADA, Tokyo (JP); Keisuke MORITA, Tokyo (JP)

(73) Assignee: Mitsubishi Electric Corporation, Tokyo (JP)

(21) Appl. No.: 19/126,553

(22) PCT Filed: Jan. 11, 2023
(86) PCT No.: PCT/JP2023/000347

§ 371 Date: May 1, 2025

(51) Int. Cl. G05D 1/667; G05D 105/28; G05D 107/70; G06Q 10/0834

(52) U.S. Cl. CPC G05D 1/667; G06Q 10/08345; G05D 2105/28; G05D 2107/70

(57) ABSTRACT

There is provided a conveyance system that enables a company that introduces the conveyance system to recover a cost in proportion to a handling amount of a delivery center. The conveyance system includes a communication unit to transmit work information indicating the number of times of conveyance of a trailer by a conveyance vehicle, a reception unit to receive the work information, a storage unit to store the work information received by the reception unit, a calculation unit to calculate a delivery fee on the basis of the work information stored in the storage unit, and a transmission unit to transmit fee information indicating the delivery fee calculated by the calculation unit to a customer.

### TECHNICAL FIELD

The present disclosure relates to a conveyance system, a conveyance method, and a conveyance vehicle used in the conveyance system.

### BACKGROUND ART

There is a delivery center as a facility serving as a base of transportation and delivery of goods. For example, a truck that tows a trailer loaded with articles enters the delivery center, and the trailer loaded with the articles is parked on the site of the delivery center. The articles loaded on the trailer are carried into a warehouse provided in the delivery center, and the trailer from which the articles are unloaded is parked on the site of the delivery center as an empty trailer. Further, articles carried out from the warehouse are loaded on the empty trailer. Thereafter, the trailer on which the articles are loaded is towed by the truck and carried out from the delivery center, whereby the articles are transported. As described above, articles are transported using the delivery center as a base.

In order to implement transportation of articles based on such a delivery center, it is necessary to convey the trailer from a position where the trailer is parked to a warehouse provided in the delivery center or to convey the trailer from the warehouse to a parking position. Conventionally, a trailer has been conveyed by man power using a vehicle driven by a human or a conveyance device such as a trailer dolly. On the other hand, it is demanded to automatically or semi-automatically convey the trailer using a conveyance vehicle such as an autonomous driving vehicle capable of autonomous traveling.

Regarding a system for conveying a trailer by a conveyance vehicle, a system for engaging a trailer parked on a site of a delivery center and moving the trailer to a door of a warehouse is disclosed. Specifically, it is disclosed that, for example, a route configured to avoid an obstacle in a site is guided, a conveyance vehicle includes a LiDAR for collision avoidance while traveling, and a position of the conveyance vehicle is determined using a beacon arranged in the site (see, for example, Patent Literature 1).

### CITATION LIST

### Patent Literature

Patent Literature 1: US 2019/0064835 A

### SUMMARY OF INVENTION

### Technical Problem

The handling amount of the delivery center is based on the processing capacity of the conveyance vehicle, and there is a possibility that operation delay of the delivery center may occur due to illness of an operator or the like. Such a problem can be solved by automatically or semi-automatically carrying out the conveyance of the trailer by the conveyance vehicle as in the prior art, but on the other hand, when introducing the conveyance system, there is a problem that a company that introduces the conveyance system cannot recover the cost in proportion to the handling amount of the delivery center.

The present disclosure has been made to solve the above-described problems, and an object of the present disclosure is to provide a conveyance system, a conveyance method, and a conveyance vehicle used in the conveyance system that enable a company that introduces a conveyance system to recover a cost in proportion to a handling amount of a delivery center.

### Solution to Problem

A conveyance system according to the present disclosure is a conveyance system for connecting a conveyance vehicle to a trailer parked on a site of a delivery center and moving the trailer to a warehouse provided in the delivery center or a parking lot of the delivery center by the conveyance vehicle, the conveyance system including: a communication unit to transmit work information indicating a number of times of conveyance of the trailer by the conveyance vehicle; a reception unit to receive the work information; a storage unit to store the work information received by the reception unit; a calculation unit to calculate a delivery fee on the basis of the work information stored in the storage unit; and a transmission unit to transmit fee information indicating the delivery fee calculated by the calculation unit to a customer.

Further, a conveyance vehicle according to the present disclosure is a conveyance vehicle used in the conveyance system according to the present disclosure, the conveyance vehicle including: a driving control unit to execute driving control on the basis of a travel plan generated by a travel plan generating unit to generate a travel plan of a conveyance vehicle included in the conveyance system, the travel plan being used to execute conveyance of the trailer from the parking lot to the warehouse or conveyance of the trailer from the warehouse to the parking lot by the conveyance vehicle.

Further, a conveyance method according to the present disclosure is a conveyance method for connecting a conveyance vehicle to a trailer parked on a site of a delivery center and moving the trailer to a warehouse provided in the delivery center or a parking lot of the delivery center by the conveyance vehicle, the conveyance method including: transmitting, by a communication unit, work information indicating a number of times of conveyance of the trailer by the conveyance vehicle, and receiving, by a reception unit, the work information; storing, by a storage unit, the work information received by the reception unit; calculating, by a calculation unit, a delivery fee in proportion to the work information stored in the storage unit; and transmitting, by a transmission unit, fee information indicating the delivery fee calculated by the calculation unit to a customer.

### Advantageous Effects of Invention

According to the present disclosure, it is possible for a company that introduces a conveyance system to recover a cost in proportion to a handling amount of a delivery center.

### BRIEF DESCRIPTION OF DRAWINGS

FIG. 1 is an explanatory diagram illustrating a delivery center according to a first embodiment.

FIG. 2 is an explanatory diagram illustrating an arrangement example of roadside sensors according to the first embodiment.

FIG. 3 is an explanatory diagram illustrating a connection relationship among a control device, a conveyance vehicle, and a roadside sensor according to the first embodiment.

FIG. 4 is a configuration diagram illustrating a configuration of the control device according to the first embodiment.

FIG. 5 is a configuration diagram illustrating a configuration of a driving control device provided in the conveyance vehicle according to the first embodiment.

FIG. 6 is an explanatory diagram illustrating a connecting operation between the conveyance vehicle and a trailer according to the first embodiment.

FIG. 7 is a flowchart illustrating an operation example of the control device and the driving control device at the time of conveying the trailer according to the first embodiment.

FIG. 8 is an explanatory diagram illustrating an operation example of the conveyance vehicle according to the first embodiment.

FIG. 9 is an explanatory diagram illustrating an operation example of the conveyance vehicle according to the first embodiment.

FIG. 10 is an explanatory diagram illustrating an operation example of the conveyance vehicle according to the first embodiment.

FIG. 11 is an explanatory diagram illustrating an operation example of the conveyance vehicle according to the first embodiment.

FIG. 12 is an explanatory diagram illustrating an operation example of the conveyance vehicle according to the first embodiment.

FIG. 13 is an explanatory diagram illustrating an operation example of the conveyance vehicle according to the first embodiment.

FIG. 14 is an explanatory diagram illustrating an operation example of the conveyance vehicle according to the first embodiment.

FIG. 15 is an explanatory diagram illustrating an operation example of the conveyance vehicle according to the first embodiment.

FIG. 16 is an explanatory diagram illustrating an operation example of the conveyance vehicle according to the first embodiment.

FIG. 17 is an explanatory diagram illustrating an operation example of the conveyance vehicle according to the first embodiment.

FIG. 18 is a configuration diagram illustrating a configuration of a management server according to the first embodiment.

FIG. 19 is a flowchart illustrating an operation example of the management server according to the first embodiment.

FIG. 20 is a diagram illustrating a hardware configuration example of the conveyance system according to the first embodiment.

FIG. 21 is an explanatory diagram illustrating a calculation example of a delivery fee according to a second embodiment.

FIG. 22 is a flowchart illustrating an operation example of a management server according to the second embodiment.

### DESCRIPTION OF EMBODIMENTS

Hereinafter, embodiments will be described with reference to the drawings. A conveyance system 100 in the present disclosure will be described using an example in which a truck 6 towing a trailer 5 enters a delivery center 1 and the trailer 5 is towed by the truck 6 and leaves the delivery center 1, but the conveyance system 100 in the present disclosure is applicable to at least one that causes the conveyance vehicle 4 to move the trailer 5. Note that, in the present disclosure, transportation and delivery are not distinguished from each other, and they are collectively referred to as delivery. In addition, in the present disclosure, a truck and a tractor are not distinguished, and an extraneous vehicle that tows the trailer 5 is described as a truck.

### First Embodiment

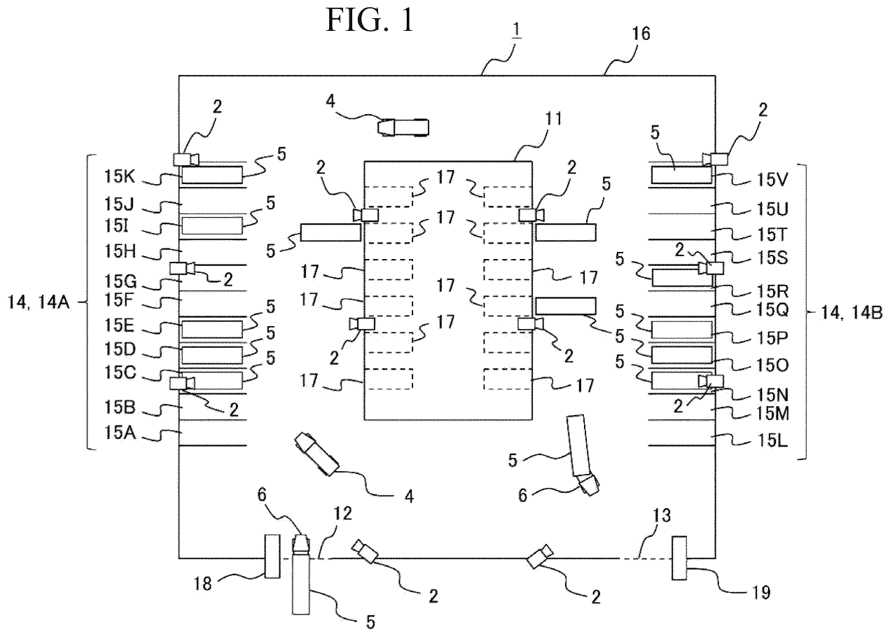

FIG. 1 is an explanatory diagram illustrating the delivery center 1 according to a first embodiment. FIG. 1 is a schematic overhead view of the delivery center 1. The delivery center 1 includes a warehouse 11 in which articles are stored, an entrance 12 and an exit 13 provided for the truck 6 or the like towing the trailer 5 on which articles are loaded to enter and exit the site of the delivery center 1, and a parking lot 14 provided in the site and being an area where the trailer 5 is parked. In addition, the delivery center 1 is provided with sensors (hereinafter, referred to as roadside sensors 2) that are fixed to a structure present in the delivery center 1 and detects at least an object in the site.

The delivery center 1 is surrounded by a fence 16 and the like, and the inside and the outside of the site are partitioned by the fence 16. FIG. 1 illustrates an example in which the delivery center 1 has a rectangular site for easy description, but the site of the delivery center 1 may have any shape.

The warehouse 11 of the delivery center 1 is provided in the site of the delivery center 1, and is arranged, for example, in the center of the site. The warehouse 11 stores articles unloaded from the trailer 5 or articles to be loaded on the trailer 5. The warehouse 11 is provided with one or more doors 17, and articles are carried into the warehouse 11 via the doors 17. In addition, an article stored in the warehouse 11 is carried out via the door 17 of the warehouse 11 and loaded on the trailer 5 when being a delivery target.

In the example of FIG. 1, the doors 17 on which articles are carried out and the doors 17 on which articles are carried in are illustrated without distinction, but for example, the doors 17 illustrated on the left side in FIG. 1 may be doors on which articles are carried in, and the doors 17 illustrated on the right side in FIG. 1 may be doors on which articles are carried out. Note that, although details will be described later, the movement of the trailer 5 is executed by one or a plurality of conveyance vehicles 4 traveling on the site of the delivery center 1.

The entrance 12 of the delivery center 1 is provided to be connected to a road outside the site, and the truck 6 can enter the site from the outside of the site through the entrance 12. Further, an entrance gate 18 is provided at the entrance 12 of the delivery center 1, and the truck 6 that can enter is managed by a monitoring staff or the like stationed at the entrance gate 18, and entry of an unauthorized truck 6 is restricted. Furthermore, the driver of the truck 6 entering the delivery center 1 is directed to a parking space 15, where the trailer 5 is to be parked, by the monitoring staff or the like stationed at the entrance gate 18. Note that the parking space 15 in which the truck 6 parks the trailer 5 may be determined by a control device 3 to be described later.

Similarly to the entrance 12 of the delivery center 1, the exit 13 of the delivery center 1 is provided to be connected to a road outside the site, and the truck 6 can exit from the site to the outside of the site via the exit 13. Further, an exit gate 19 is provided at the exit 13 of the delivery center 1, and the exiting truck 6 is managed by a monitoring staff or the like stationed at the exit gate 19. Note that, in the example of FIG. 1, the entrance 12 and the exit 13 are provided at different locations, but the entrance 12 and the exit 13 may be provided at the same location.

One or a plurality of parking lots 14 of the delivery center 1 is provided in the site of the delivery center 1, and a plurality of parking spaces 15 is provided in each of the parking lots 14. Each parking space 15 is partitioned by a marker such as a white line, and each parking space 15 has, for example, a width equal to or larger than the vehicle width of the trailer 5 in such a manner that the trailer 5 can be parked.

In the example of FIG. 1, the plurality of parking lots 14 is provided at positions facing the doors 17 of the warehouse 11. Hereinafter, for the sake of description, the parking lot 14 on the left side in FIG. 1 is referred to as a parking lot 14A, and the parking lot 14 on the right side in FIG. 1 is referred to as a parking lot 14B. In addition, the parking spaces 15 provided in the parking lot 14A are referred to as parking spaces 15A to 15K in order from the lower side in FIG. 1, and the parking spaces 15 provided in the parking lot 14B are referred to as parking spaces 15L to 15V in order from the lower side in FIG. 1. Note that, in a case where it is not necessary to distinguish the parking lots 14A and 14B, it is simply described as the parking lot 14, and in a case where it is not necessary to distinguish the parking spaces 15A to 15V, it is simply described as the parking space 15.

In the parking space 15, trailers 5 on which articles are loaded or empty trailers 5 on which no article is loaded are parked, and in the example of FIG. 1, the trailers 5 are parked in the parking spaces 15C, 15D, 15E, 15I, 15K, 15N, 15O, 15P, 15R, and 15V, and the parking spaces 15A, 15B, 15F, 15G, 15H, 15J, 15L, 15M, 15Q, 15S, 15T, and 15U are vacant spaces on which no trailer 5 is parked. Hereinafter, one or a plurality of parking spaces 15 in which a vacant space equal to or larger than the vehicle width of the trailer 5 is ensured is referred to as a parkable section. That is, in the example of FIG. 1, the parking spaces 15A, 15B, 15F, 15G, 15H, 15J, 15L, 15M, 15Q, 15S, 15T, and 15U are parkable sections. Note that a plurality of adjacent parkable sections may be one parking section.

The roadside sensors 2 provided in the delivery center 1 include, for example, at least one of a camera, a sonar, a light detection and ranging (LiDAR), a radio wave sensor, or the like, and detects mobile objects including a truck 6, a conveyance vehicle 4, a pedestrian, and the like, an obstacle present on the site of the delivery center 1, and a surrounding feature present on the site of the delivery center 1. Note that, in the example of FIG. 1, illustration of some roadside sensors 2 is omitted for simplification.

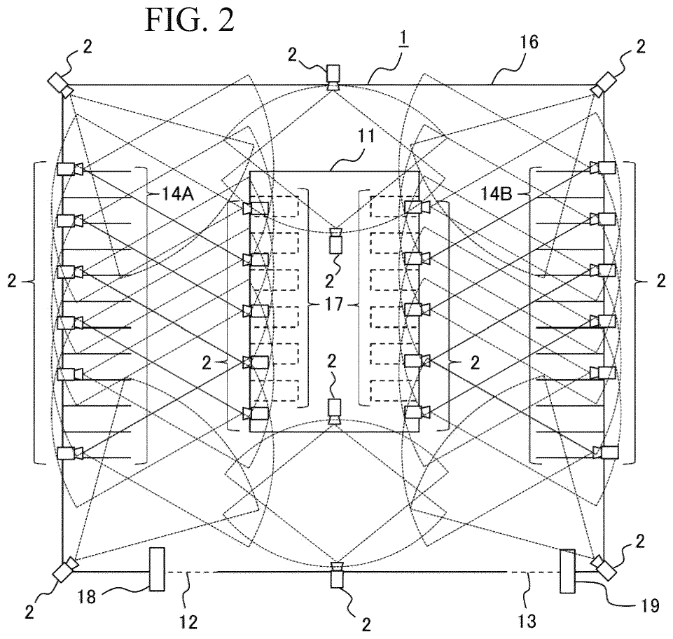

FIG. 2 is an explanatory diagram illustrating an arrangement example of the roadside sensors 2 according to the first embodiment. In the example of FIG. 2, the detection range of the roadside sensor 2 is indicated by a broken line. The roadside sensors 2 are fixed to a structure such as a roof of the warehouse 11, the fence 16 of the delivery center 1, or a support provided in the delivery center 1, and a plurality of roadside sensors 2 is provided on the site of the delivery center 1. The roadside sensors 2 are arranged so as to include at least the parking lot 14 and the door 17 of the warehouse 11 in a detection range formed by one or a plurality of roadside sensors 2. In addition, it is preferable that the plurality of roadside sensors 2 is provided so as to include the entire site of the delivery center 1 in the detection range.

Sensor information acquired by the roadside sensor 2 is transmitted to the control device 3 via a communication unit (not illustrated) included in the roadside sensor 2, and is used for generation of a travel plan of the conveyance vehicle 4 or braking and driving control of the conveyance vehicle 4 to be described later, but in the delivery center 1, there are many objects having larger dimensions such as the truck 6 and the trailer 5 as compared with general roads such as public roads. In addition, in the site of the delivery center 1, there is no clear distinction between a section in which the truck 6 or the conveyance vehicle 4 can travel and a section in which a human such as a worker can move, and there are various mobile objects coming and going.

That is, the environment of the delivery center 1 and the environment of ordinary roads are greatly different in that there are many blind spots and various mobile objects in the delivery center 1. Thus, in the delivery center 1, it is preferable to arrange a plurality of roadside sensors 2 in order to suppress the occurrence of blind spots for the roadside sensors 2. In the example of FIG. 2, the roadside sensors 2 fixed to the fence 16 or the like of the delivery center 1 and arranged on the parking lot 14 side are arranged, for example, facing the warehouse 11 in such a manner that at least a part of the door 17 of the warehouse 11 such as one or a plurality of doors 17 of the warehouse 11 falls within the detection range. On the other hand, the roadside sensors 2 fixed to the roof or the like of the warehouse 11 and arranged on the warehouse 11 side are arranged, for example, facing the parking lot 14 in such a manner that at least a part of the parking lot 14 such as one or a plurality of parking spaces 15 falls within the detection range.

When the roadside sensors 2 are arranged in this manner, an object present in the parking lot 14, an object present in the door 17, and an object present in a passage between the parking lot 14 and the door 17 can be detected by the plurality of roadside sensors 2. In addition, since the roadside sensors 2 are arranged to face each other, for example, even if the truck 6 crosses the passage between the parking lot 14 and the warehouse 11 and a blind spot is generated for the roadside sensors 2 arranged on the side of the parking lot 14 because it is hidden by the truck 6, the blind spot is included in the detection range of the roadside sensors 2 arranged on the side of the warehouse 11. On the other hand, even if a blind spot is generated for the roadside sensor 2 arranged on the side of the warehouse 11 because it is hidden by the truck 6, the blind spot is included in the detection range of the roadside sensors 2 arranged on the side of the parking lot 14.

In addition, for example, even when the trailer 5, the truck 6, or the like is present on a passage on which the conveyance vehicle 4 or the truck 6 travels, and an object is present in a range that is a blind spot for an external sensor 415 to be described later mounted on the conveyance vehicle 4, the object can be detected by the roadside sensor 2. Thus, in the generation of a travel plan of the conveyance vehicle 4 or the braking and driving control of the conveyance vehicle 4 to be described later, it is possible to prevent collision with an object popping out from a blind area for the traveling conveyance vehicle 4. In addition, since the conveyance vehicle 4, the trailer 5, the truck 6, or the worker present in the parking lot 14 or the door 17 is constantly or intermittently detected, a travel plan avoiding the parking space 15 and the door 17 in which the conveyance vehicle 4, the trailer 5, the truck 6, or the worker is present can be generated by the control device 3, and operation efficiency of the delivery center 1 can be improved.

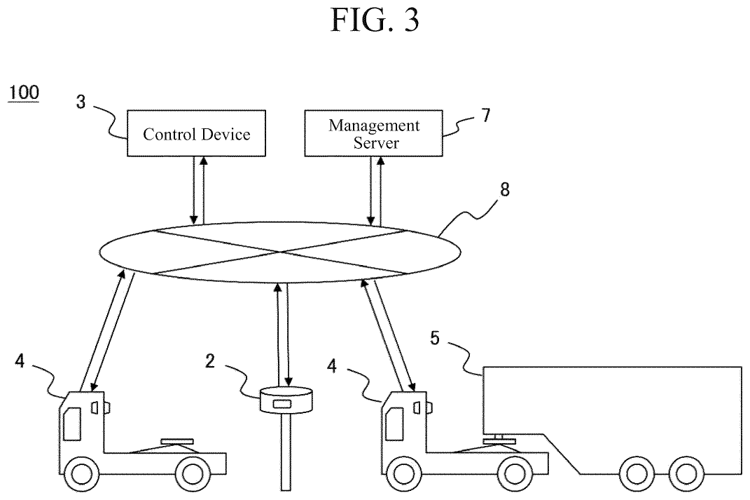

FIG. 3 is an explanatory diagram illustrating a connection relationship among the control device 3, the conveyance vehicles 4, and the roadside sensor 2 according to the first embodiment. The roadside sensor 2 and the conveyance vehicles 4 traveling in the delivery center 1 communicate with the control device 3 via a network 8. Although details will be described later, the control device 3 receives in-vehicle sensor information transmitted from the conveyance vehicle 4 and roadside sensor information transmitted from the roadside sensor 2 via the network 8, and generates a travel plan of the conveyance vehicle 4 using the in-vehicle sensor information and the roadside sensor information. That is, the conveyance system 100 is a system including the control device 3 and the conveyance vehicle 4 in the configuration. Details of a management server 7 illustrated in FIG. 3 will be described later.

In addition, the control device 3 transmits the travel plan to the convey ance vehicle 4 via the network 8. Then, the conveyance vehicle 4 executes autonomous traveling and conveyance of the trailer 5 on the basis of the received travel plan. Hereinafter, the in-vehicle sensor information transmitted from the conveyance vehicle 4 and the roadside sensor information transmitted from the roadside sensor 2 may be collectively referred to as sensor information. Note that the conveyance vehicle 4 or the roadside sensor 2 may be connected to an edge server (not illustrated) that processes sensor information, and the edge server may be connected to the control device 3 via the network 8.

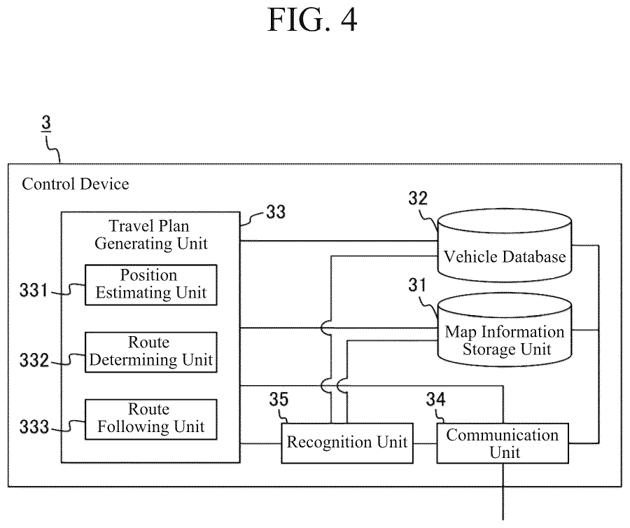

The control device 3 will be described. FIG. 4 is a configuration diagram illustrating a configuration of the control device 3 according to the first embodiment. The control device 3 includes a map information storage unit 31 that stores map information of the delivery center 1, a vehicle database 32 that is a database capable of storing information of the conveyance vehicle 4 and the trailer 5 present in the delivery center 1, a travel plan generating unit 33 that generates a travel plan used for autonomous travel of the conveyance vehicle 4, a communication unit 34 that communicates with the roadside sensor 2 and the convey ance vehicle 4, and a recognition unit 35 that generates peripheral recognition information for recognizing the environment in the site of the delivery center 1. Note that at least one of the map information storage unit 31, the vehicle database 32, the travel plan generating unit 33, the communication unit 34, and the recognition unit 35 included in the control device 3 may be provided in the edge server. That is, for example, the recognition unit 35 may be provided in the edge server, and the edge server may transmit the peripheral recognition information to the control device 3.

The map information stored in the map information storage unit 31 is a highly accurate basic map used for autonomous traveling. Further, the map information includes, for example, a passage present on the site of the delivery center 1, a connection relationship of the passages, a width and a length of the passage, a road surface of the passage, position information of surrounding features such as the warehouse 11 of the delivery center 1, and the like. Note that the map information may include a highly accurate three-dimensional map reflecting position information and the like of surrounding features and obstacles. The highly accurate three-dimensional map may be constituted by, for example, a three-dimensional model of a point cloud, a line segment, a feature, and the like expressed using highly accurate three-dimensional position coordinates of a centimeter class to a submeter class according to a reference coordinate system such as a world geodetic system (WGS) or a geodetic system.

The vehicle database 32 is a database that stores information of the plurality of conveyance vehicles 4 managed by the control device 3. The vehicle database 32 stores, for example, an ID of the conveyance vehicle 4 and a state such as whether or not the conveyance vehicle 4 is executing conveyance of the trailer 5. Further, the vehicle database 32 stores information such as a parking position of the trailer 5, a type of the trailer 5, dimensions of the trailer 5, whether or not to load an article, an entry date and time, and an exit date and time as information of the trailer 5 present in the delivery center 1.

The recognition unit 35 generates peripheral recognition information for recognizing the environment in the site of the delivery center 1 on the basis of the sensor information of the in-vehicle sensor and the roadside sensor 2 acquired via the communication unit 34. Here, the environment in the site of the delivery center 1 refers to the presence or absence of an object in the site of the delivery center 1. That is, the peripheral recognition information generated by the recognition unit 35 includes position information indicating the parking position and the parkable area of the trailer 5 present in the delivery center 1.

Further, the sensor information transmitted from the in-vehicle sensor includes information sensed by the external sensor 415 that is provided in the conveyance vehicle 4 and senses the environment around the conveyance vehicle 4. The sensor information transmitted from the in-vehicle sensor may include position information acquired by a GPS receiver 414 of the conveyance vehicle 4. Furthermore, when a vehicle posture sensor, a weight sensor, or the like is provided in the conveyance vehicle 4, the sensor information transmitted from the in-vehicle sensor may include information such as a vehicle posture and an in-vehicle weight of the conveyance vehicle 4. That is, the in-vehicle sensor may include not only the external sensor 415 but also other sensors mounted on the conveyance vehicle 4.

The travel plan generating unit 33 generates the travel plan of the convey ance vehicle 4 in such a manner that the conveyance vehicle 4 autonomously travels on the travel route on the basis of the map information and the sensor information transmitted from the convey ance vehicle 4 and the roadside sensor 2.

The travel plan generating unit 33 includes a position estimating unit 331. The position estimating unit 331 estimates convey ance vehicle position information including the position of the conveyance vehicle 4 and the direction in which the conveyance vehicle 4 is facing on the basis of the map information and the sensor information. Specifically, the position estimating unit 331 estimates the convey ance vehicle position information on the basis of the peripheral recognition information and the map information.

The travel plan generating unit 33 includes a route determining unit 332. The route determining unit 332 generates a travel route of the conveyance vehicle 4 on the basis of the map information, the conveyance vehicle position information, and the peripheral recognition information. In addition, when the travel plan generating unit 33 generates a travel plan for causing the conveyance vehicle 4 to travel toward the trailer 5 or the parking space 15 for conveying the trailer 5, the travel plan generating unit 33 generates the travel route of the conveyance vehicle 4 on the basis of the map information, the conveyance vehicle position information, the peripheral recognition information, and the position information of the trailer 5 to be conveyed or the parking space 15 in which the trailer 5 is to be parked.

That is, when the convey ance vehicle 4 is caused to convey the trailer 5, the travel route includes a position where the trailer 5 as a conveyance target is parked (hereinafter, referred to as a first parking position) and a position where the trailer 5 as a conveyance target is to be parked (hereinafter, referred to as a second parking position). Note that the first parking position is, for example, the parking space 15 or the door 17 of the warehouse 11, and the second parking position is a parkable section or the door 17 of the warehouse 11.

Here, the travel route is represented, for example, by dividing a route from the current position of the conveyance vehicle 4 to a target position into a plurality of routes. That is, the travel route includes, for example, a plurality of points located up to the target position, and the plurality of points is set as points through which the conveyance vehicle 4 should pass.

The travel plan generating unit 33 includes a route following unit 333. The route following unit 333 generates control information including speed control information for controlling the speed of the conveyance vehicle 4 and direction control information for controlling the steering angle of the conveyance vehicle 4 on the basis of the travel route and the conveyance vehicle position information. Then, the travel plan generating unit 33 transmits the travel plan to the conveyance vehicle 4 via the communication unit 34.

That is, the travel plan generated by the travel plan generating unit 33 includes the travel route of the conveyance vehicle 4 and control information for the conveyance vehicle 4 to travel on the travel route. Note that the speed indicates the speed of the conveyance vehicle 4, and the steering angle indicates the traveling direction of the conveyance vehicle 4. The speed and the steering angle can be rephrased as a speed and a steering angle, or a speed and a traveling direction. Here, the travel plan transmitted from the travel plan generating unit 33 need not include the control information. In this case, a driving control unit 411 of a driving control device 41 to be described later may generate the control information so as to follow the travel route generated by the travel plan generating unit 33. When the driving control unit 411 generates the control information, the route following unit 333 of the control device 3 can be appropriately omitted.

In addition, the travel plan generating unit 33 generates the travel plan for each conveyance vehicle 4. In the case of generating the travel plan for the plurality of conveyance vehicles 4, when the travel plan is generated by the travel plan generating unit 33 in such a manner that the plurality of conveyance vehicles 4 does not interfere with each other by generating, for example, the travel route of the plurality of conveyance vehicles 4 in such a manner that the travel route of one convey ance vehicle 4 and the travel route of another conveyance vehicle 4 do not intersect, the operation efficiency of the delivery center 1 is improved because the plurality of conveyance vehicles 4 does not interfere with each other.

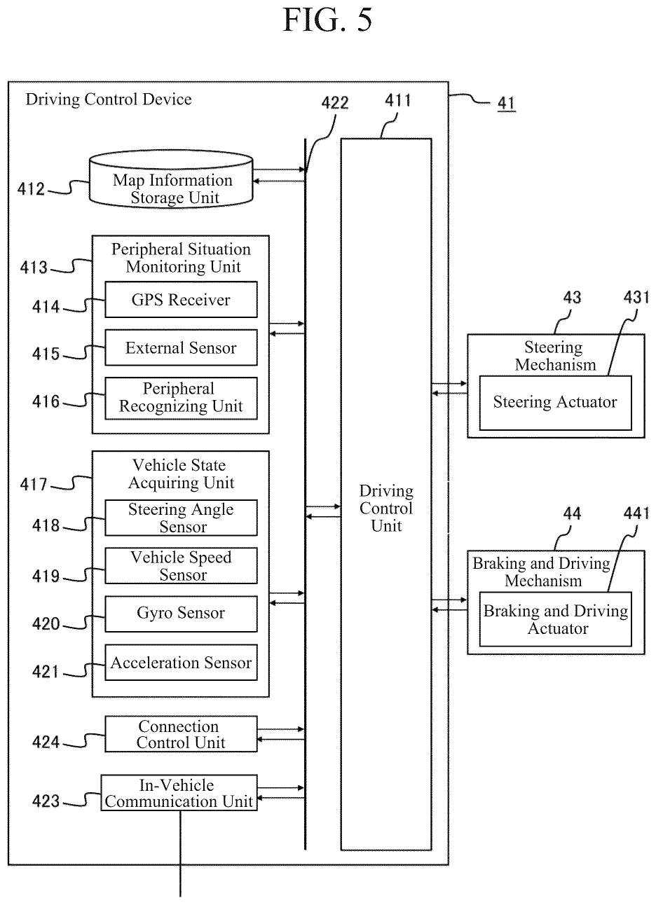

Next, a configuration of the conveyance vehicle 4 will be described. FIG. 5 is a configuration diagram illustrating a configuration of the driving control device 41 provided in the conveyance vehicle 4 according to the first embodiment. The driving control device 41 includes the driving control unit 411 that controls a steering mechanism 43 and a braking and driving mechanism 44 of the conveyance vehicle 4 to perform driving control of the conveyance vehicle 4 on the basis of the travel plan received from the control device 3. Further, the driving control device 41 includes a map information storage unit 412 that stores map information used for autonomous traveling of the conveyance vehicle 4, a peripheral situation monitoring unit 413 that monitors a peripheral situation of the conveyance vehicle 4, a vehicle state acquiring unit 417 that acquires information indicating a state of the conveyance vehicle 4 on which the driving control device 41 is mounted, an in-vehicle communication unit 423 configured to be capable of wireless communication, and a connection control unit 424 that controls connection and disconnection of the trailer 5 and the conveyance vehicle 4.

Note that the driving control unit 411, the map information storage unit 412, the peripheral situation monitoring unit 413, and the vehicle state acquiring unit 417 included in the driving control device 41 are each connected to a communication bus 422 included in the driving control device 41, and can transmit and receive data via the communication bus 422.

The steering mechanism 43 is a mechanism provided in the conveyance vehicle 4 to determine the traveling direction of the conveyance vehicle 4, and includes, for example, a steering wheel, a steering shaft, a rack, a pinion, a steering actuator 431, and the like. The braking and driving mechanism 44 is a mechanism for controlling the traveling speed of the conveyance vehicle 4 and switching between forward movement and backward movement, and includes, for example, a driving device such as an engine and a motor, an accelerator, a brake, a shift, a braking and driving actuator 441, and the like. Note that the steering actuator 431 that controls the steering mechanism 43 includes, for example, an electric power steering (EPS) motor and the like, and the braking and driving actuator 441 that controls the braking and driving mechanism 44 includes, for example, an electronically controlled throttle, a brake actuator, and the like. Further, in a case where the conveyance vehicle 4 performs only autonomous traveling, mechanisms such as a steering wheel, an accelerator, and a brake that are based on human operations are not necessary and can be appropriately omitted.

The map information storage unit 412 stores map information. The map information stored in the map information storage unit 31 is a highly accurate basic map used for autonomous traveling, similarly to the map information stored in the map information storage unit 31 included in the control device 3. Further, the map information includes, for example, a passage present on the site of the delivery center 1, a connection relationship of the passages, a width and a length of the passage, a road surface of the passage, position information of surrounding features such as the warehouse 11 of the delivery center 1, and the like. Note that the map information may include a highly accurate three-dimensional map capable of indicating a passage through which the conveyance vehicle 4 or the like can pass, a road surface of the passage, and surrounding features. In addition, the map information stored in the map information storage unit 412 may be updated by map information or the like which is delivered from the control device 3 and in which the position information of the trailer 5 is reflected.

Further, when the control device 3 includes the map information storage unit 31, the conveyance vehicle 4 can autonomously travel even if the driving control device 41 does not include the map information storage unit 412, and when the driving control device 41 includes the map information storage unit 412, the conveyance vehicle 4 can autonomously travel even if the control device 3 does not include the map information storage unit 31. That is, the map information may be stored in at least one of the map information storage unit 31 provided in the control device 3 or the map information storage unit 412 provided in the driving control device 41.

The peripheral situation monitoring unit 413 is configured to be able to monitor the situation around a host vehicle, and includes the global positioning system (GPS) receiver 414, the external sensor 415, and a peripheral recognizing unit 416.

The GPS receiver 414 receives a signal transmitted from a GPS positioning satellite, and detects the current position of the conveyance vehicle 4 as conveyance vehicle position information. Note that the driving control device 41 may include a global navigation satellite system (GNSS) receiver in addition to the GPS receiver 414, and the driving control device 41 may include a GNSS receiver instead of the GPS receiver 414.

The external sensor 415 includes, for example, at least one of a camera like that images the outside of the vehicle, a sonar, a LiDAR, a radio wave sensor, or the, and detects the position of another vehicle, a pedestrian, an obstacle, or the like present around the conveyance vehicle 4, the distance from the host vehicle, or the like.

The peripheral recognizing unit 416 recognizes the environment around the host vehicle on the basis of the conveyance vehicle position information of the conveyance vehicle 4 and the sensor information acquired from the GPS receiver 414 and the external sensor 415. Here, the environment around the host vehicle indicates, for example, the presence or absence of an object around the host vehicle, which is included in the detection range of the external sensor 415.

The in-vehicle communication unit 423 is, for example, a wireless communication device connected to an antenna for wireless communication. The in-vehicle communication unit 423 communicates with an in-vehicle communication unit provided in another conveyance vehicle 4, a communication unit installed on a road, or the like to acquire information of the position of another vehicle or a pedestrian, or the like.

In addition, the in-vehicle communication unit 423 can perform communication between the vehicle and the vehicle by wireless communication, that is, inter-vehicle communication with the in-vehicle communication unit 423 of another vehicle present around the host vehicle. Note that the in-vehicle communication unit 423 can output information received from another vehicle to the communication bus 422. Further, the in-vehicle communication unit 423 may be configured to be able to acquire information from the roadside sensor 2.

Furthermore, the in-vehicle communication unit 423 is configured to be able to transmit the information generated by the driving control device 41 and output to the communication bus 422 to the control device 3 and another vehicle. That is, the sensor information transmitted from the conveyance vehicle 4 to the control device 3 may include conveyance vehicle position information, a speed, a steering angle, or the like in addition to the sensor information acquired by the external sensor 415.

The vehicle state acquiring unit 417 acquires information indicating the state of the host vehicle, and includes a steering angle sensor 418, a vehicle speed sensor 419, a gyro sensor 420, and an acceleration sensor 421.

The steering angle sensor 418 is provided in, for example, an EPS motor or a steering wheel, and detects a steering angle of the host vehicle. The vehicle speed sensor 419 is provided on a wheel, for example, and detects a traveling speed of the host vehicle.

The gyro sensor 420 is a sensor that detects an angular velocity in an azimuth direction when the conveyance vehicle 4 turns. The acceleration sensor 421 is a sensor that detects acceleration in a front-rear direction (for example, in a vehicle length direction), a left-right direction (for example, in a vehicle width direction), and an up-down direction (for example, in a vehicle height direction) of the conveyance vehicle 4. Note that, even when the position information of the conveyance vehicle 4 cannot be acquired from the GPS receiver 414 or the like, the position of the conveyance vehicle 4 can be estimated using the angular velocity and the acceleration in each direction acquired by the gyro sensor 420 and the acceleration sensor 421.

The driving control unit 411 of the driving control device 41 controls the steering actuator 431 or the braking and driving actuator 441 mounted on the host vehicle to execute autonomous traveling. The driving control unit 411 performs driving control of the host vehicle by outputting a signal to the steering actuator 431, the braking and driving actuator 441, or the like, for example.

The driving control unit 411 controls the braking and driving actuator 441 including, for example, an electronically controlled throttle, a brake actuator, and the like to perform braking and driving control of the host vehicle such as operating the brake to decelerate or stop the host vehicle. The driving control unit 411 controls the steering actuator 431 including, for example, an EPS motor and performs steering control of the host vehicle such as maintaining a travel route on which the host vehicle travels.

That is, the driving control unit 411 generates control information and controls the steering actuator 431 and the braking and driving actuator 441 so as to follow the travel route included in the travel plan received from the control device 3, thereby implementing autonomous traveling of the conveyance vehicle 4 based on the travel plan. In addition, the driving control unit 411 may control the steering actuator 431 and the braking and driving actuator 441 using the control information included in the travel plan so as to follow the travel route included in the travel plan received from the control device 3, thereby implementing autonomous traveling of the conveyance vehicle 4 based on the travel plan. Note that, when the conveyance vehicle 4 is configured to be able to be driven by a person, a display device (not illustrated) may be provided in the conveyance vehicle 4, and the travel route included in the travel plan received from the control device 3 may be displayed on the display device to enable the conveyance vehicle 4 to travel based on the travel plan.

In addition, when the external sensor 415 mounted on the conveyance vehicle 4 detects the presence of an obstacle in the travel route and determines that there is a risk of contact between the conveyance vehicle 4 and the obstacle, the driving control unit 411 executes emergency stop control for automatically stopping the conveyance vehicle 4. When the emergency stop control is started, the driving control unit 411 stops the conveyance vehicle 4 on the spot. When executing the emergency stop control, the driving control unit 411 may cause the peripheral situation monitoring unit 413 to search for an evacuation place where the host vehicle is stopped, and move the conveyance vehicle 4 to the evacuation place to stop the conveyance vehicle 4. Note that the above-described evacuation place is preferably a position that does not hinder the movement of other mobile objects, such as outside the travel routes of other conveyance vehicles 4.

The connection control unit 424 lifts and lowers a fifth wheel 45 provided on a base or the like of the conveyance vehicle 4, and executes connection or disconnection of the conveyance vehicle 4 and the trailer 5. The connection control unit 424 transmits a signal to a lift 46 provided in the conveyance vehicle 4 to drive the lift 46, thereby executing lifting and lowering of the fifth wheel 45.

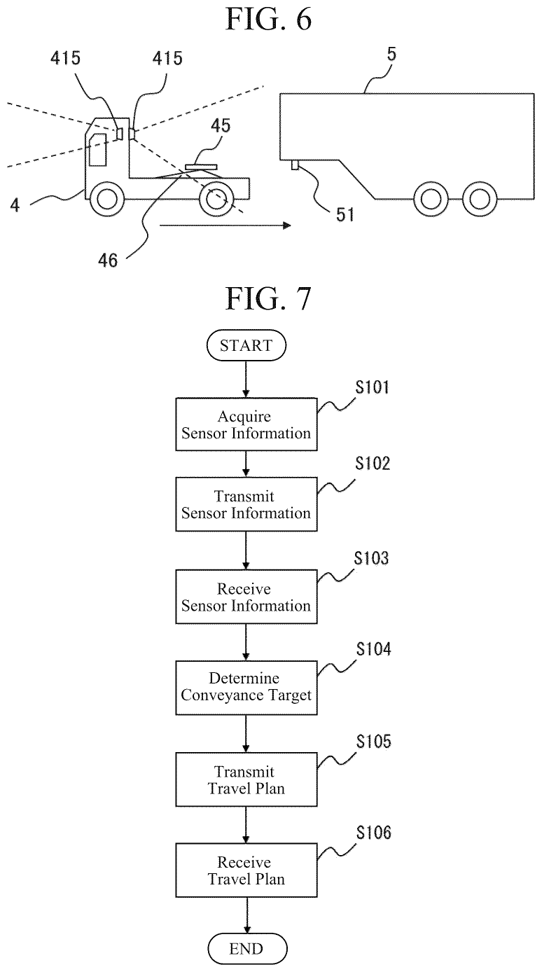

The connection and disconnection of the conveyance vehicle 4 and the trailer 5 will be described. FIG. 6 is an explanatory diagram illustrating a connecting operation of the conveyance vehicle 4 and the trailer 5 according to the first embodiment. When connecting with the trailer 5 is executed, the conveyance vehicle 4 approaches the trailer 5 as the conveyance target on the basis of the travel plan. Next, under the driving control of the driving control unit 411, the conveyance vehicle 4 executes direction change as necessary in such a manner that the base provided with the fifth wheel 45 faces the direction in which the trailer 5 is disposed, and moves to a position where a king pin 51 provided at the lower portion of the trailer 5 and the fifth wheel 45 can be engaged with each other. Note that, in the example of FIG. 6, the base of the conveyance vehicle 4 extends toward the rear side (the right side in FIG. 6) of the conveyance vehicle 4, and the fifth wheel 45 is provided on the base. That is, in the example of FIG. 6, the conveyance vehicle 4 moves backward and approaches the trailer 5. Then, the connection control unit 424 of the conveyance vehicle 4 drives the lift 46 to raise the fifth wheel 45, engages the fifth wheel 45 with the king pin 51, and completes the connection between the conveyance vehicle 4 and the trailer 5.

In the connection operation between the conveyance vehicle 4 and the trailer 5 described above, the conveyance vehicle 4 needs to approach the trailer 5, but when the conveyance vehicle 4 and the trailer 5 approach each other, the space between the conveyance vehicle 4 and the trailer 5 may be a blind spot for the external sensor 415 mounted on another conveyance vehicle 4 or a blind spot for the roadside sensors 2. Thus, the driving control unit 411 preferably executes driving control of the conveyance vehicle 4 connected to the trailer 5 using the sensor information acquired by the external sensor 415 provided in the conveyance vehicle 4 connected to the trailer 5.

In addition, in a case of disconnecting the conveyance vehicle 4 and the trailer 5, the conveyance vehicle 4 moves the trailer 5 to the parking position, and then drives the lift 46 by the connection control unit 424 to lower the fifth wheel 45, thereby completing the disconnecting of the conveyance vehicle 4 and the trailer 5. Note that, when it is necessary to connect a pneumatic line for supplying air pressure from the conveyance vehicle 4, a cable for supplying electric power from the conveyance vehicle 4, or the like to the trailer 5, a robot having a manipulator may be mounted on the base of the conveyance vehicle 4, and the connection of the pneumatic line, the cable, or the like may be automatically executed by the robot. Even in a case where the pneumatic line for supplying air pressure from the conveyance vehicle 4, a cable for supplying power from the conveyance vehicle 4, or the like is detached from the trailer 5, the detachment may be automatically executed by the above-described robot. In this case, a signal indicating that connection or disconnection between the conveyance vehicle 4 and the trailer 5 is finished or started may be transmitted by the in-vehicle communication unit 423 to a control device (not illustrated) that controls the robot, and the robot may connect or detach the cable or the like.

Next, operations of the control device 3 and the driving control device 41 will be described. FIG. 7 is a flowchart illustrating an operation example of the control device 3 and the driving control device 41 at the time of conveying the trailer 5 according to the first embodiment.

In step S101, the external sensor 415 or the roadside sensor 2 of the conveyance vehicle 4 acquires sensor information. Specifically, the external sensor 415 or the roadside sensor 2 including a camera, a sonar, a radio wave sensor, LiDAR, or the like senses the site of the delivery center 1.

In step S102, the communication unit of the roadside sensor 2 or the in-vehicle communication unit 423 of the conveyance vehicle 4 transmits sensor information obtained by sensing to the control device 3.

In step S103, the communication unit 34 of the control device 3 receives the sensor information from the roadside sensor 2 and the conveyance vehicle 4. Note that step S101, step S102, and step S103 may be repeatedly executed.

Then, in step S104, the travel plan generating unit 33 of the control device 3 determines the trailer 5 as the conveyance target. That is, the travel plan generating unit 33 specifies the first parking position where the trailer 5 as the convey ance target is parked and the second parking position where the trailer 5 as the conveyance target is to be parked.

Note that the trailer 5 as the convey ance target may be determined on the basis of a recognition result of the recognition unit 35 or may be determined by a manager of the delivery center 1 who operates the control device 3 via a user interface. In the case of determining the trailer 5 as the conveyance target on the basis of the recognition result of the recognition unit 35, for example, when the recognition unit 35 detects the trailer 5 parked in the parking lot 14 and the door 17 on which no other trailer 5 or the like is present, the travel plan generating unit 33 determines the trailer 5 parked in the parking lot 14 as the conveyance target. Further, for example, when the recognition unit 35 detects the trailer 5 parked on the door 17 after the loading or unloading work of the article is completed and the parkable section, the travel plan generating unit 33 determines the trailer 5 parked on the door 17 as the conveyance target.

In step S105, the travel plan generating unit 33 generates a travel plan and transmits the travel plan to the conveyance vehicle 4 via the communication unit 34. Specifically, the recognition unit 35 of the control device 3 generates the peripheral recognition information for recognizing the surroundings of the conveyance vehicle 4 on the basis of the sensor information received in step S103.

Here, the conveyance vehicle 4 for which the travel plan generating unit 33 is to generate the travel plan may be the conveyance vehicle 4 that is not engaged in the conveyance of the trailer 5 or completes the conveyance of the trailer 5 after a predetermined time has elapsed, among the plurality of conveyance vehicles 4. Information regarding the operation state of the conveyance vehicle 4, such as whether or not each conveyance vehicle 4 is engaged in the conveyance of the trailer 5 or the time when the conveyance of the trailer 5 ends, is stored in the vehicle database 32 of the control device 3. Note that, for example, information indicating whether or not each of the conveyance vehicles 4 is engaged in the conveyance of the trailer 5 may be stored in the vehicle database 32 using a signal indicating that the conveyance vehicle 4 has started or ended the conveyance of the trailer 5 acquired by the control device 3 from the driving control unit 411. Further, for example, on the basis of the travel plan generated by the travel plan generating unit 33, the travel plan generating unit 33 may estimate the time when the conveyance of the trailer 5 ends, and use the time as the information regarding the operation state of the conveyance vehicle 4. In addition, the control device 3 may acquire information of whether the conveyance vehicle 4 is connected to or disconnected from the trailer 5 from the connection control unit 424 of the driving control device 41, and store the information in the vehicle database 32 as information regarding the operation state of the conveyance vehicle 4.

The position estimating unit 331 of the travel plan generating unit 33 estimates the conveyance vehicle position information on the basis of the recognition information and the map information. For example, the position estimating unit 331 estimates the conveyance vehicle position information using a simultaneous localization and mapping (SLAM) technology that simultaneously estimates the position of the conveyance vehicle 4 and creates an environmental map. In addition to the SLAM technique, by using the position information by the GPS included in the sensor information transmitted from the conveyance vehicle 4, the conveyance vehicle position information can be estimated more accurately.

Then, the travel plan generating unit 33 generates a travel plan and transmits the travel plan to the conveyance vehicle 4 via the communication unit 34. Specifically, the route determining unit 332 of the travel plan generating unit 33 generates the travel route of the conveyance vehicle 4 on the basis of the map information, the conveyance vehicle position information, and the peripheral recognition information.

Next, the route following unit 333 of the travel plan generating unit 33 generates control information including speed control information for controlling the speed of the conveyance vehicle 4 and direction control information for controlling the steering angle of the conveyance vehicle 4 on the basis of the travel route and the conveyance vehicle position information. Then, the communication unit 34 of the control device 3 transmits the travel plan to the conveyance vehicle 4.

In step S106, the in-vehicle communication unit 423 of the conveyance vehicle 4 receives the travel plan. Then, the travel plan is input to the driving control unit 411. Here, the driving control unit 411 of the conveyance vehicle 4 may generate a signal indicating that the conveyance of the trailer 5 has started and transmit the signal to the control device 3 via the in-vehicle communication unit 423. Note that, when the control information is not included in the travel plan transmitted from the travel plan generating unit 33, the driving control unit 411 of the driving control device 41 may generate the control information in such a manner that the conveyance vehicle 4 follows the travel route.

The driving control unit 411 controls the speed and the steering angle on the basis of the travel plan. Thus, the conveyance vehicle 4 autonomously travels on the travel route on the basis of the travel plan. The conveyance vehicle 4 moves to the first parking position on the basis of the travel plan, and is connected to the trailer 5 as the conveyance target present at the first parking position. Then, after the convey ance vehicle 4 conveys the trailer 5 to the second parking position, the trailer 5 is disconnected and the trailer 5 is parked at the second parking position. Here, the driving control unit 411 of the conveyance vehicle 4 may generate a signal indicating that the conveyance of the trailer 5 has ended, and transmit the signal to the control device 3 via the in-vehicle communication unit 423.

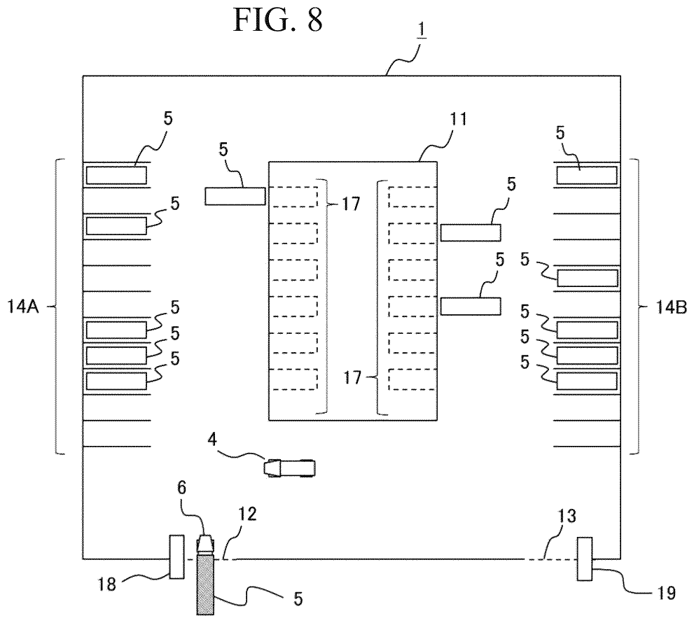

An operation of the conveyance vehicle 4 related to entry of the truck 6 towing the trailer 5 and conveyance of the trailer 5 to the warehouse 11 by the conveyance vehicle 4 will be described. FIGS. 8 to 13 are explanatory diagrams illustrating operation examples of the conveyance vehicle 4 according to the first embodiment. In FIGS. 8 to 13, the roadside sensor 2 is not illustrated for simplicity. The trailer 5 as the conveyance target of the conveyance target 4 is hatched.

The entry of the truck 6 towing the trailer 5 will be described with reference to FIG. 8. The truck 6 towing the trailer 5 enters the site of the delivery center 1 from the entrance 12 of the delivery center 1. When the monitoring staff at the entrance gate 18 permits the driver of the truck 6 to enter the delivery center 1, the driver of the truck 6 is designated the parking space 15 where the trailer 5 is to be parked. Note that the monitoring staff may instruct the driver of the truck 6 about the parking space 15 in which the trailer 5 is to be parked. In addition, the parking space 15 in which the trailer 5 is to be parked may be determined by the driver of the truck 6.

Here, the parking position of the trailer 5 is stored in the vehicle database 32 of the control device 3 together with, for example, information such as the type of the trailer 5, the dimensions of the trailer 5, whether or not to load an article, and the entry date and time. Here, when the control device 3 does not instruct the conveyance of the trailer 5, the convey ance vehicle 4 waits at a position that does not hinder the movement of the truck 6 or other conveyance vehicles 4. Note that a standby place for the conveyance vehicle 4 may be provided in the site of the delivery center 1 as a position that does not hinder the movement of the truck 6 or other conveyance vehicles 4.

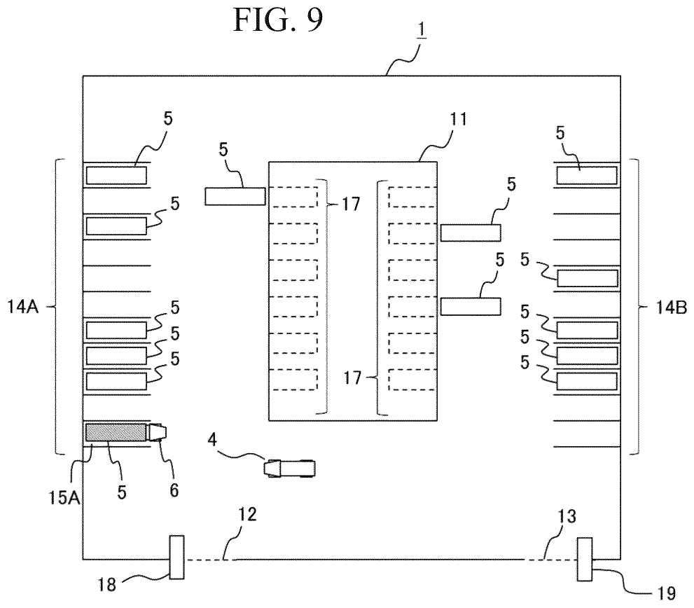

Parking of the trailer 5 by the truck 6 will be described with reference to FIG. 9. The truck 6 permitted to enter parks the trailer 5 in the designated parking space 15. In the example of FIG. 9, the designated parking space 15 is the parking space 15A.

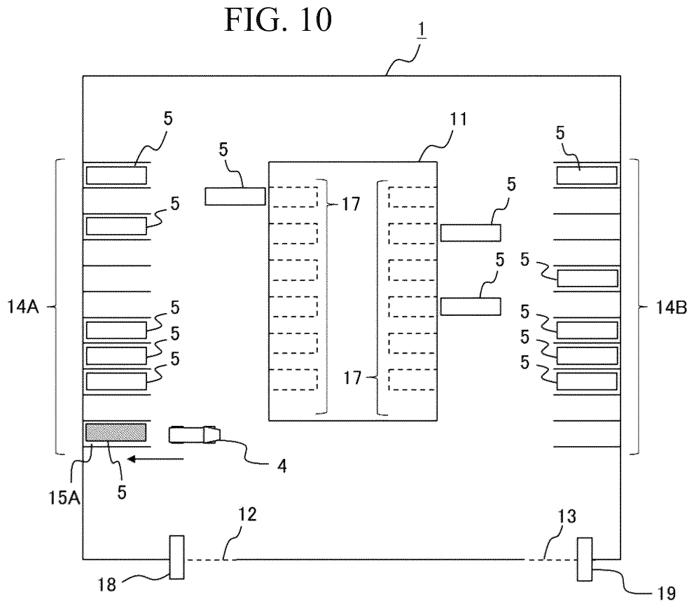

The connection between the conveyance vehicle 4 and the trailer 5 will be described with reference to FIG. 10. The conveyance vehicle 4 instructed to convey the trailer 5 by the control device 3 autonomously travels from the current position such as a standby position to the first parking position that is included in the travel plan transmitted from the control device 3 and is a position where the trailer 5 of the conveyance vehicle 4 is parked. Then, the conveyance vehicle 4 is connected to the trailer 5 by executing control by the driving control unit 411 and the connection control unit 424.

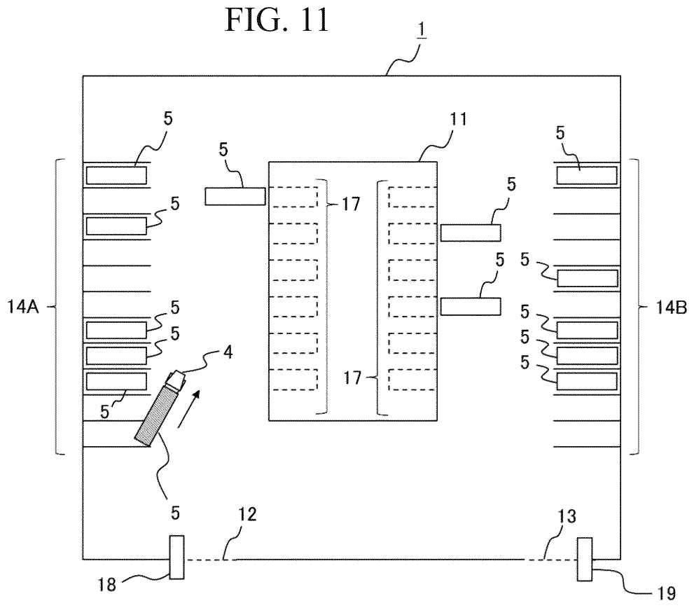

The conveyance of the trailer 5 to the door 17 by the conveyance vehicle 4 will be described with reference to FIG. 11. The conveyance vehicle 4 connected to the trailer 5 moves the trailer 5 to the second parking position, which is a position at which the trailer 5 is to be parked, included in the travel plan transmitted from the control device 3. When the trailer 5 is conveyed to the door 17 by the conveyance vehicle 4, the second parking position is the door 17 for loading or unloading articles.

Here, the door 17 set as the second parking position may be one door 17 among the doors 17 on which no other conveyance vehicle 4 or trailer 5 is present specified by the peripheral recognition information generated by the recognition unit 35 of the control device 3, or may be one door 17 among the plurality of doors 17 designated by the manager or the like of the delivery center 1. In a case of designation by the manager or the like of the delivery center 1, the second parking position may be input to the control device 3 via the interface.

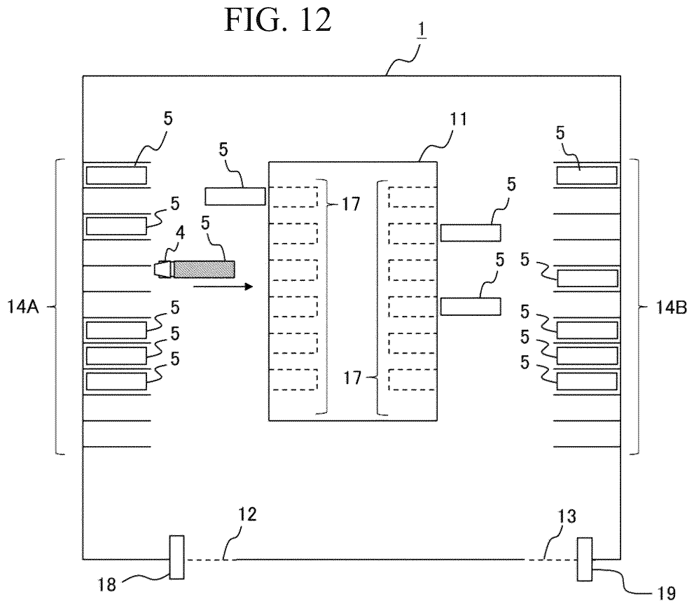

Parking of the trailer 5 to the door 17 by the conveyance vehicle 4 will be described with reference to FIG. 12. The conveyance vehicle 4 connected to the trailer 5 conveys the trailer 5 to the door 17 on which articles are loaded or unloaded, and changes the direction as necessary so as to arrange the open door provided on the trailer 5 on the door 17 side. Thereafter, the convey ance vehicle 4 causes the trailer 5 to approach the door 17 in such a manner that articles can be loaded or unloaded, and executes control by the connection control unit 424 to be disconnected from the trailer 5. Note that the parking position of the trailer 5 disconnected from the conveyance vehicle 4 may be stored in the vehicle database 32 of the control device 3 together with, for example, information such as the type of the trailer 5, the dimensions of the trailer 5, whether or not to load articles, and the parking date and time.

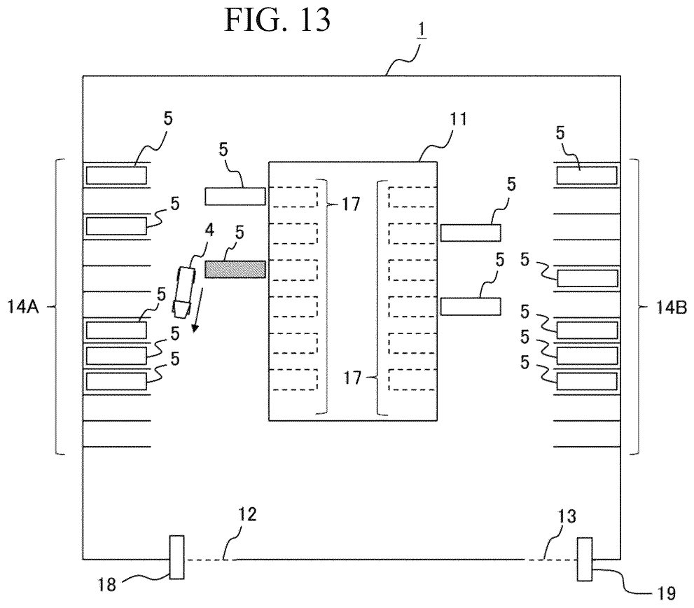

The operation of the conveyance vehicle 4 when the conveyance of the trailer 5 by the conveyance vehicle 4 is completed will be described with reference to FIG. 13. The conveyance vehicle 4 disconnected from the trailer 5 and having the trailer 5 parked at the door 17, that is, the second parking position, is separated from the trailer 5 by autonomous traveling and waits at a position that does not interfere with the movement of the truck 6 or other conveyance vehicles 4, such as a standby place. In addition, the conveyance vehicle 4 disconnected from the trailer 5 may start the conveyance of another trailer 5 without waiting. As described above, the conveyance vehicle 4 conveys the trailer 5 from the parking space 15 to the door 17.

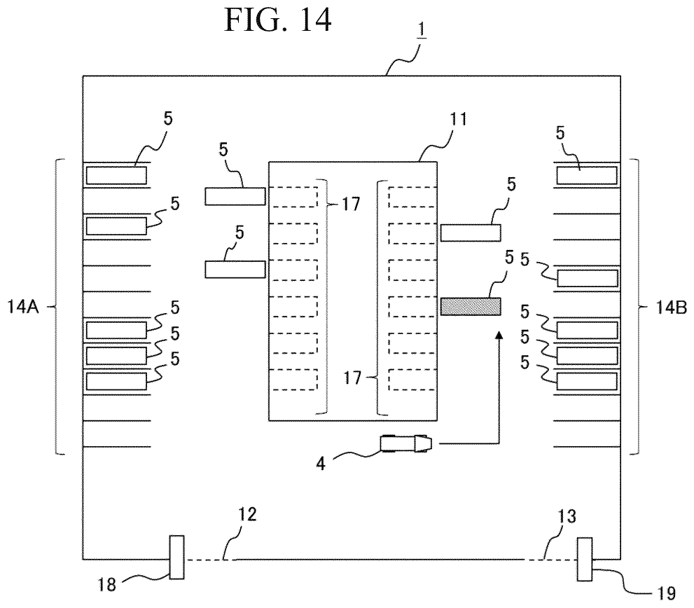

Next, the operation of the conveyance vehicle 4 related to the conveyance of the trailer 5 by the conveyance vehicle 4 from the warehouse 11 and the exit of the truck 6 towing the trailer 5 will be described. FIGS. 14 to 17 are explanatory diagrams illustrating the operation of the conveyance vehicle 4 according to the first embodiment. In FIGS. 14 to 17, the roadside sensor 2 is not illustrated for simplicity. The trailer 5 as the conveyance target of the conveyance target 4 is hatched.

With reference to FIG. 14, autonomous traveling of the convey ance vehicle 4 to a position where the trailer 5 is parked will be described. The conveyance vehicle 4 instructed to convey the trailer 5 by the control device 3 autonomously travels from the current position such as a standby position to the first parking position that is included in the travel plan transmitted from the control device 3 and is a position where the trailer 5 of the conveyance vehicle 4 is parked. Note that, in the example of FIG. 14, the first parking position is the door 17 of the warehouse 11.

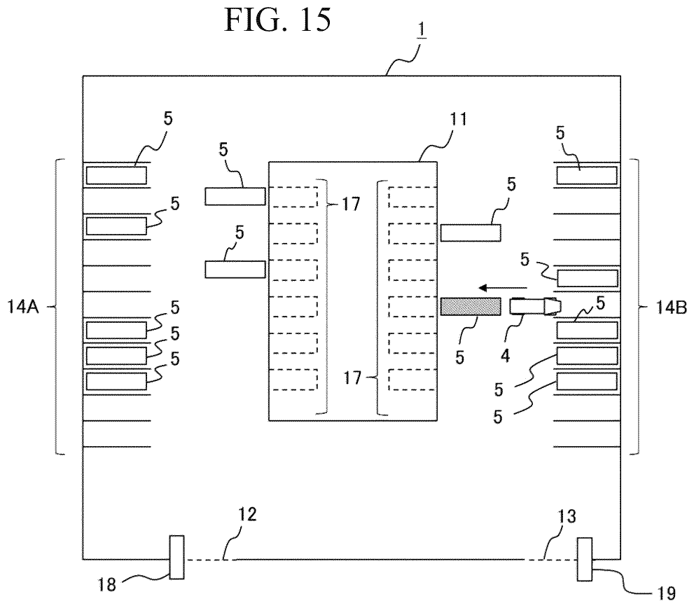

The connection between the conveyance vehicle 4 and the trailer 5 will be described with reference to FIG. 15. The conveyance vehicle 4 moved to the first parking position is connected to the trailer 5 by executing control by the driving control unit 411 and the connection control unit 424.

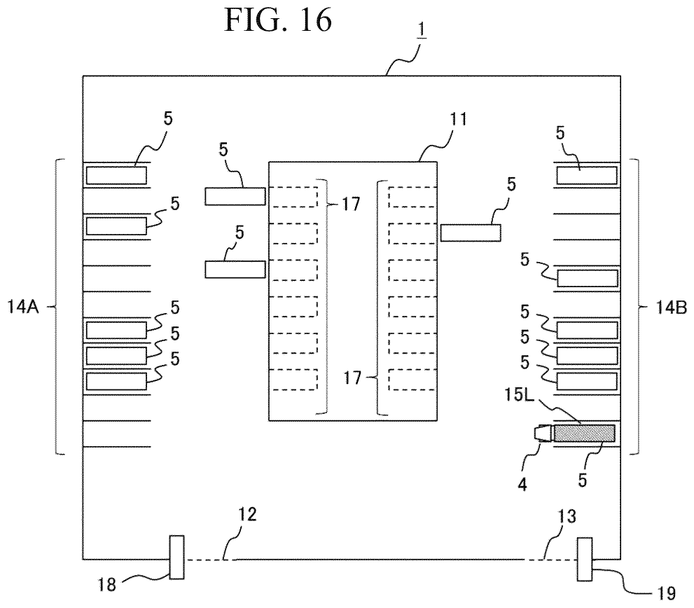

The conveyance of the trailer 5 to the parking space 15 by the conveyance vehicle 4 will be described with reference to FIG. 16. The conveyance vehicle 4 connected to the trailer 5 moves the trailer 5 to the second parking position, which is a position at which the trailer 5 is to be parked, included in the travel plan transmitted from the control device 3. When the trailer 5 is conveyed to the parking space 15 by the conveyance vehicle 4, the second parking position is a parkable section.

Thereafter, the conveyance vehicle 4 changes the direction as necessary in such a manner that the trailer 5 can be towed by the truck 6, and is disconnected from the trailer 5 in the parking space 15 to park the trailer 5. Here, the parking position of the trailer 5 may be stored in the vehicle database 32 of the control device 3 together with, for example, information such as the type of the trailer 5, the dimensions of the trailer 5, whether or not to load the article, and the parking date and time. Note that, in the example of FIG. 16, the parking position of the trailer 5 is the parking space 15L. As described above, the conveyance vehicle 4 conveys the trailer 5 from the door 17 to the parking space 15.

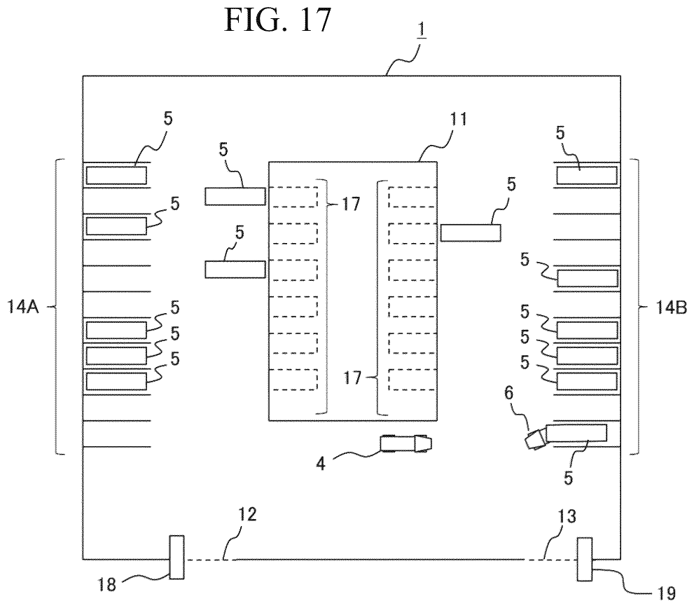

Towing of the trailer 5 by the truck 6 will be described with reference to FIG. 17. The truck 6 permitted to enter tows the trailer 5 designated by the monitoring staff or the like of the entrance gate 18, and carries the trailer 5 out of the delivery center 1 via the exit gate 19 of the delivery center 1. Here, the conveyance vehicle 4 that has completed the conveyance of the trailer 5 may be caused to wait at a position that does not hinder the movement of the truck 6 or another conveyance vehicle 4.

Incidentally, in introduction of the above-described conveyance system 100, in a case where a company that introduces the conveyance system 100 is different from a company that manages and operates the delivery center 1, there is a case where a business form is employed in which the company that introduces the conveyance system 100 recovers a cost in proportion to a handling amount of the delivery center 1, and the recovered cost is also used to introduce the conveyance system 100 to a company that operates another delivery center 1. However, there is a problem that the company that introduces the conveyance system 100 cannot recover the cost in proportion to the handling amount of the delivery center 1 due to a circumstance that the operating state of the conveyance vehicle 4 cannot be grasped, or the like.

Accordingly, the conveyance system 100 included in the control device 3 of the present disclosure includes a management server 7, and the management server 7 calculates the cost in proportion to the handling amount of the delivery center 1 and charges the cost to the company that manages and operates the delivery center 1, so that the company that introduces the conveyance system 100 can recover the cost in proportion to the handling amount of the delivery center 1.

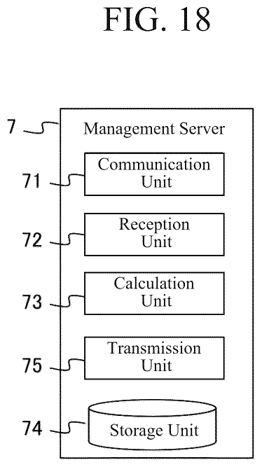

FIG. 18 is a configuration diagram illustrating a configuration of the management server 7 according to the first embodiment. The management server 7 includes a reception unit 72 that receives work information indicating the number of times of conveyance of the trailer 5 by the convey ance vehicle 4, a storage unit 74 that stores the work information received by the reception unit 72, a calculation unit 73 that calculates a delivery fee in proportion to the work information stored in the storage unit 74, and a transmission unit 75 that transmits fee information indicating the delivery fee calculated by the calculation unit 73 to the customer. Here, a customer is, for example, a company that manages and operates the delivery center 1.

Further, the management server 7 is connected to a delivery center server of a company that manages and operates the control device 3 and the delivery center 1 via a network. The management server 7 transmits and receives data to and from the control device 3 and the delivery center server via the communication unit 71. The data transmitted from the control device 3 to the management server 7 is work information indicating the number of times of convey ance of the trailer 5 by the convey ance vehicle 4, and data transmitted from the management server 7 to the delivery center server is fee information indicating the delivery fee. For example, the fee information is transmitted by the transmission unit 75 in a format in which the company managing and operating the delivery center 1 can recognize the cost charged by an e-mail or the like.

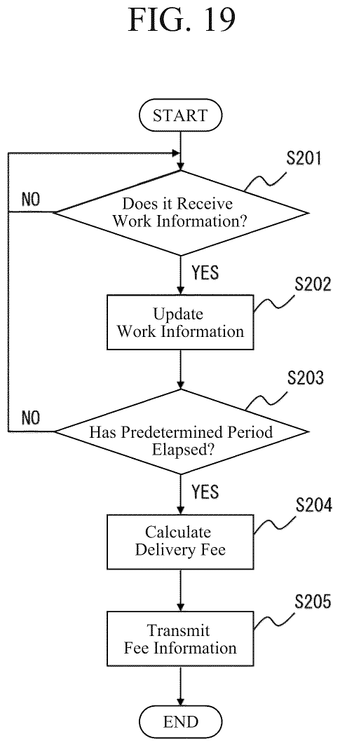

A method of charging the delivery fee by the management server 7 will be described. FIG. 19 is a flowchart illustrating an operation example of the management server 7 according to the first embodiment. In step S201, the reception unit 72 of the management server 7 receives the work information indicating the number of times of conveyance of the trailer 5 by the conveyance vehicle 4. Note that, when the reception unit 72 of the management server 7 has not received the work information indicating the number of times of conveyance of the trailer 5 by the conveyance vehicle 4 (S201: NO), the processing does not proceed to step S202, and the management server 7 waits until the work information is received.

The work information is transmitted from the control device 3 or the conveyance vehicle 4 to the management server 7, for example. An example of a case where the work information is transmitted from the control device 3 to the management server 7 will be described. The travel plan generating unit 33 of the control device 3 generates a travel plan including the first parking position and the second parking position. Next, when receiving a signal indicating that the conveyance of the trailer 5 has been completed on the basis of the generated travel plan from the conveyance vehicle 4, the control device 3 stores the number of times of performing the conveyance work of the trailer 5 in the vehicle database 32 in association with the ID of the conveyance vehicle 4 that has carried out the conveyance work. Then, the number of times the conveyance vehicle 4 has performed the conveyance work of the trailer 5 is transmitted to the management server 7 as the work information via the communication unit 34 of the control device 3, and the reception unit 72 of the management server 7 receives the number of times the conveyance vehicle 4 has performed the conveyance work of the trailer 5 as the work information.

Further, an example of a case where the work information is transmitted from the conveyance vehicle 4 to the management server 7 will be described. The driving control device 41 of the conveyance vehicle 4 stores, for example, the number of times the connection control unit 424 has executed the connection between the conveyance vehicle 4 and the trailer 5 and the disconnection between the conveyance vehicle 4 and the trailer 5 in a storage unit (not illustrated) provided in the driving control device 41. Then, the driving control device 41 transmits, to the management server 7 via the in-vehicle communication unit 426, the number of times the connection control unit 424 has executed the connection between the conveyance vehicle 4 and the trailer 5 and the disconnection between the conveyance vehicle 4 and the trailer 5 as the work information. Next, the reception unit 72 of the management server 7 receives, as the work information, the number of times the connection control unit 424 has executed the connection between the conveyance vehicle 4 and the trailer 5 and the disconnection between the conveyance vehicle 4 and the trailer 5.

Here, the number of times of conveyance of the trailer 5 is, for example, the number of times of conveyance of the trailer 5 from the parking lot 14 to the door 17 by the conveyance vehicle 4, the number of times of conveyance of the trailer 5 from the door 17 to the parking lot 14 by the conveyance vehicle 4, or the number of times obtained by adding the number of times of conveyance of the trailer 5 from the parking lot 14 to the door 17 by the conveyance vehicle 4, and the number of times of conveyance of the trailer 5 from the door 17 to the parking lot 14 by the conveyance vehicle 4.

Further, the number of times of conveyance of the trailer 5 may be calculated using the above-described number of times, for example, the number of times obtained by adding each of the number of times of conveyance of the trailer 5 from the parking lot 14 to the door 17 by the convey ance vehicle 4, the number of times of conveyance of the trailer 5 from the door 17 to the parking lot 14 by the conveyance vehicle 4, and the number of times obtained by adding the number of times of conveyance of the trailer 5 from the parking lot 14 to the door 17 by the conveyance vehicle 4, the number of times of conveyance of the trailer 5 from the door 17 to the parking lot 14 by the conveyance vehicle 4, and the like.

Furthermore, the number of times of convey ance of the trailer 5 may be calculated using the sensor information acquired by the roadside sensor 2 or sensor information acquired by an in-vehicle sensor provided in the conveyance vehicle 4. For example, the number of times of conveyance of the trailer 5 by the conveyance vehicle 4 may be measured using the detection result of the roadside sensor 2 including the door 17 in the detection range or the external sensor 415 among the in-vehicle sensors and the detection result of the roadside sensor 2 or the external sensor 415 including the parking lot 14 in the detection range.

After the reception unit 72 of the management server 7 receives the work information indicating the number of times of conveyance of the trailer 5 by the conveyance vehicle 4 (S201: YES), in step S202, the storage unit 74 of the management server 7 stores the work information received by the reception unit 72. Further, when the work information is stored in the storage unit 74 of the management server 7, the work information is updated using the work information received by the reception unit 72 in step S202.

Then, in step S203, the calculation unit 73 of the management server 7 determines whether or not a predetermined period has elapsed. When the elapse of the predetermined period is checked (S203: YES), in step S204, the calculation unit 73 calculates the delivery fee in proportion to the work information stored in the storage unit 74. For example, the calculation unit 73 refers to the work information stored in the storage unit 74 to specify the number of times of conveyance of the trailer 5 by the conveyance vehicle 4, and calculates a fee proportional to the number of times of conveyance as the delivery fee.

Here, the predetermined period is, for example, a predetermined period starting from the previous calculation of the delivery fee by the calculation unit 73 or the previous transmission of the fee information by the transmission unit 75. Regarding determination by the calculation unit 73 as to whether or not the predetermined period has elapsed, for example, it is sufficient that, when one month has elapsed from the time of calculation of the previous delivery fee by the calculation unit 73, it is determined that the predetermined period has elapsed, and when one month has not elapsed from the time of calculation of the previous delivery fee by the calculation unit 73, it is determined that the predetermined period has not elapsed. Further, regarding the determination as to whether or not the predetermined period has elapsed by the calculation unit 73, for example, it is sufficient that, when one month has elapsed from the previous transmission of the fee information by the transmission unit 75, it is determined that the predetermined period has elapsed, and when one month has not elapsed from the previous transmission of the fee information by the transmission unit 75, it is determined that the predetermined period has not elapsed. That is, the delivery fee is calculated by the calculation unit 73 on the basis of the number of times of conveyance of the trailer 5 during the above-described predetermined period. Note that, when it is checked that the predetermined period has not elapsed (S203: NO), the processing proceeds to step S201, and the management server 7 continues the collection of the work information.

In step S205, the transmission unit 75 of the management server 7 transmits the fee information indicating the delivery fee calculated by the calculation unit 73 to the customer. The transmission unit 75 transmits the fee information by an electronic mail or the like in a format in which the company managing and operating the delivery center 1 can recognize the charged cost. Thereafter, the processing proceeds to step S201, and the management server 7 continues the collection of the work information.

Note that, in the management server 7 described above, an example has been described in which the number of times of conveyance is calculated on the basis of the conveyance work of the trailer 5 executed by the conveyance vehicle 4, but the number of times of conveyance may be calculated using the number of the trailers 5 towed by the truck 6 and entering the delivery center 1 or the number of the trailers 5 towed by the truck 6 and exiting the delivery center 1. For example, the number of trailers 5 that have entered the delivery center 1 may be calculated using the number of trailers 5 detected by the roadside sensor 2 whose detection range includes the entrance gate 18 or the in-vehicle sensor, and the number of trailers 5 exiting the delivery center 1 may be calculated using the number of trailers 5 detected by the roadside sensor 2 whose detection range includes the exit gate 19 or the in-vehicle sensor. In this manner, it is possible to charge the cost based on the number of trailers 5 that have been conveyed by the conveyance vehicle 4, and the cost to be charged to the customer corresponds to the processing capacity of the delivery center 1 such as the scale of the delivery center 1, the loading efficiency of articles, the loading/unloading efficiency of articles, or the carrying efficiency of the trailer 5 by the conveyance vehicle 4.

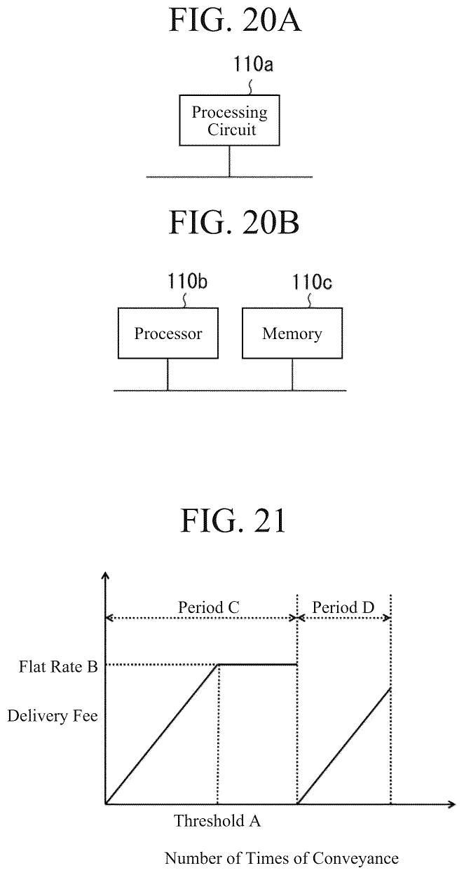

Next, a hardware configuration that implements the functions of the conveyance system 100 will be described. FIG. 20 is a diagram illustrating a hardware configuration example of the convey ance system 100 according to the first embodiment. The functions of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 in the conveyance system 100 are implemented by a processing circuit. That is, the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 of the conveyance system 100 may be a processing circuit 110a that is dedicated hardware as illustrated in FIG. 20A, or may be a processor 110b that executes a program stored in a memory 110c as illustrated in FIG. 20B.

As illustrated in FIG. 20A, when the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 are dedicated hardware, the processing circuit 110a corresponds to, for example, a single circuit, a composite circuit, a programmed processor, a parallel-programmed processor, an application specific integrated circuit (ASIC), a field-programmable gate array (FPGA), or a combination thereof. Each of the functions of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 may be implemented by a processing circuit, or the functions of the units may be collectively implemented by one processing circuit.

As illustrated in FIG. 20B, when the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 are the processor 110b, the functions of the units are implemented by software, firmware, or a combination of software and firmware. The software or firmware is described as a program and stored in the memory 110c. The processor 110b reads and executes the program stored in the memory 110c, thereby implementing the functions of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75. That is, the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 include the memory 110c for storing programs that result in execution of each step illustrated in FIG. 7 and the like when executed by the processor 110b. It can also be said that these programs cause a computer to execute the procedures or methods of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75.

Here, the processor 110b is, for example, a central processing unit (CPU), a processing device, an arithmetic device, a processor, a microprocessor, a microcomputer, a digital signal processor (DSP), or the like. The memory 110c may be, for example, a nonvolatile or volatile semiconductor memory such as a random access memory (RAM), a read only memory (ROM), a flash memory, an erasable programmable ROM (EPROM), or an electrically EPROM (EEPROM), a magnetic disk such as a hard disk or a flexible disk, or an optical disk such as a mini disk, a compact disc (CD), or a digital versatile disc (DVD).

Note that some of the functions of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 may be implemented by dedicated hardware, and some may be implemented by software or firmware. As described above, the processing circuit 110a in the conveyance system 100 can implement the above-described functions by hardware, software, firmware, or a combination thereof. In addition, at least some of the functions of the control device 3, the map information storage unit 31, the vehicle database 32, the travel plan generating unit 33, the communication unit 34, the recognition unit 35, the position estimating unit 331, the route determining unit 332, the route following unit 333, the driving control device 41, the driving control unit 411, the map information storage unit 412, the peripheral situation monitoring unit 413, the peripheral recognizing unit 416, the vehicle state acquiring unit 417, the in-vehicle communication unit 423, the connection control unit 424, the management server 7, the communication unit 71, the reception unit 72, the calculation unit 73, the storage unit 74, and the transmission unit 75 may be executed by a server present outside the conveyance system 100.

In this manner, when the conveyance system 100 includes the communication units 34 and 423 that transmit the work information indicating the number of times of conveyance of the trailer 5 by the conveyance vehicle 4, the reception unit 72 that receives the work information, the storage unit 74 that stores the work information received by the reception unit 72, the calculation unit 73 that calculates the delivery fee in proportion to the work information stored in the storage unit 74, and the transmission unit 75 that transmits the fee information indicating the delivery fee calculated by the calculation unit 73 to the customer, the company that introduces the conveyance system 100 can recover the cost in proportion to the handling amount of the delivery center 1.

### Second Embodiment

A conveyance system 100 according to a second embodiment is different from that of the first embodiment in that when the number of times of conveyance exceeds a predetermined number of times, the management server 7 calculates the delivery fee as a flat rate. The same components as those in the first embodiment are denoted by the same reference numerals, and the description thereof will be omitted.

For example, the calculation unit 73 included in the management server 7 refers to the work information stored in the storage unit 74, specifies the number of times of conveyance of the trailer 5 by the convey ance vehicle 4, and calculates a fee proportional to the number of times of conveyance as the delivery fee. Here, the predetermined period is, for example, a predetermined period starting from the previous transmission of the fee information by the transmission unit 75. Regarding determination by the calculation unit 73 as to whether or not the predetermined period has elapsed, for example, it is sufficient that, when one month has elapsed from the time of calculation of the previous delivery fee by the calculation unit 73, the calculation unit 73 determines that the predetermined period has elapsed. Further, the delivery fee is calculated by the calculation unit 73 on the basis of the number of times of conveyance of the trailer 5 during the above-described predetermined period.

FIG. 21 is an explanatory diagram illustrating an example of calculation of a delivery fee according to the second embodiment. In the graph illustrated in FIG. 21, the vertical axis represents the delivery fee, and the horizontal axis represents the number of times of conveyance. When the number of times of conveyance of the trailer 5 exceeds a predetermined threshold (in FIG. 21, threshold A), the calculation unit 73 calculates the delivery fee as a fixed fee (In FIG. 21, flat rate B). That is, the delivery fee charged to the customer is a flat rate (in FIG. 21, delivery fee calculated in period C) when the number of times of convey ance exceeds a predetermined threshold, and is a fee (in FIG. 21, delivery fee calculated in period D) proportional to the number of times of conveyance, for example, when the number of times of conveyance is equal to or less than the predetermined threshold.

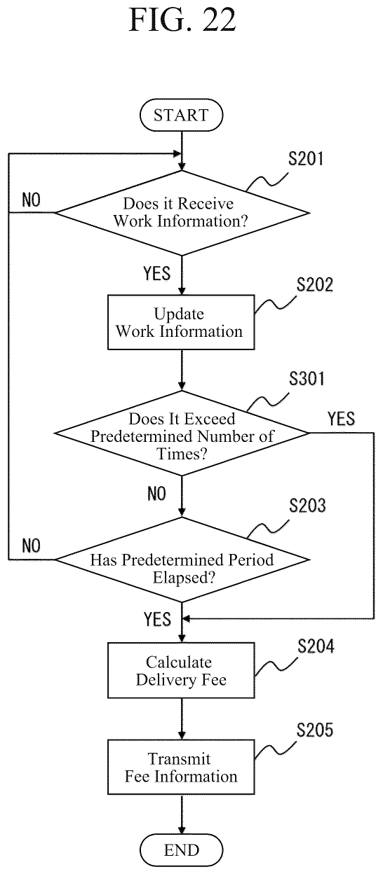

FIG. 22 is a flowchart illustrating an operation example of the management server 7 according to the second embodiment. The processes described in FIG. 19 are denoted by the same reference numerals, and description thereof is omitted. In step S201, the reception unit 72 of the management server 7 receives the work information indicating the number of times of conveyance of the trailer 5 by the convey ance vehicle 4.

After the reception unit 72 of the management server 7 receives the work information indicating the number of times of conveyance of the trailer 5 by the conveyance vehicle 4 (S201: YES), the storage unit of the management server 7 stores the work information received by the reception unit 72 in step S202. Further, when the work information is stored in the storage unit of the management server 7, the work information is updated using the work information received by the reception unit 72 in step S202. Note that, when the reception unit 72 of the management server 7 has not received the work information indicating the number of times of conveyance of the trailer 5 by the convey ance vehicle 4 (S201: NO), the processing does not proceed to step S202, and the management server 7 waits until the work information is received.

Next, in step S301, the calculation unit 73 checks whether or not the number of times of conveyance of the trailer 5 exceeds the predetermined threshold. When it is checked that the number of times of conveyance of the trailer 5 has exceeded the predetermined threshold (S301: YES), the processing proceeds to S204, and the calculation unit 73 calculates the delivery fee and determines the delivery fee to be flat-rate. Then, the processing proceeds to S205, and the transmission unit 75 of the management server 7 transmits the fee information indicating the delivery fee calculated by the calculation unit 73 to the customer.

Note that the transmission of the fee information indicating the delivery fee to the customer by the transmission unit 75 may be executed after the elapse of a predetermined period, such as after the elapse of a predetermined period starting from the previous transmission of the fee information by the transmission unit 75. In this manner, when the calculation unit 73 determines that the delivery fee is a flat rate, work by the conveyance vehicle 4 after the delivery fee is determined during the predetermined period is not added to the delivery fee, and the delivery fee indicated by the fee information transmitted from the transmission unit 75 to the customer can be set as the flat rate.

When it is checked that the number of times of conveyance of the trailer 5 is equal to or less than the predetermined threshold (S301: NO), the processing proceeds to S203, and the calculation unit 73 of the management server 7 confirms whether or not a predetermined period has elapsed. When the elapse of the predetermined period is checked (S203: YES), in step S204, the calculation unit 73 calculates the delivery fee in proportion to the work information stored in the storage unit 74. Then, the processing proceeds to S205, and the transmission unit 75 transmits the fee information indicating the delivery fee calculated by the calculation unit 73 to the customer. Thereafter, the processing of the management server 7 proceeds to the processing of step S201 and continues the collection of the work information. Note that, when it is checked that the predetermined period has not elapsed (S203: NO), the processing proceeds to step S201 to continue the collection of the work information.

As described above, in a case where the number of times of conveyance exceeds the predetermined number of times in the conveyance system 100, when the delivery fee is calculated as the flat rate, the company managing and operating the delivery center 1 improves the conveyance efficiency of the trailer 5 without putting pressure on profits even if the number of times of conveyance increases. While the profit obtained from one conveyance system 100 is reduced, the company who prompts the introduction of the conveyance system 100 can also prompt the company of another delivery center to introduce a new conveyance system 100 from the introduction results, and thus, it is possible to improve the overall profit by introducing the convey ance system 100 to a plurality of delivery centers.

Note that, in the first to second embodiments, a part of the configuration of the control device 3 may be provided in the driving control device 41 of the conveyance vehicle 4 or the edge server. In addition, a part of the configuration of the driving control device 41 of the conveyance vehicle 4 may be provided in the control device 3 or the edge server. Furthermore, the control device 3 and the edge server may be provided in the delivery center 1 or may be provided in a facility outside the delivery center 1.

Note that embodiments disclosed in the present specification can be appropriately modified or omitted within the scope thereof.

### REFERENCE SIGNS LIST

1: delivery center, 2: roadside sensor, 3: control device, 4: conveyance vehicle, 5: trailer, 6: truck, 7: management server, 11: warehouse, 12: entrance, 13: exit, 14, 14A to B: parking lot, 15, 15A to V: parking space, 16: fence, 17: door, 18: entrance gate, 19: exit gate, 31, 412: map information storage unit, 32: vehicle database, 33: travel plan generating unit, 34, 71: communication unit, 35: recognition unit, 41: driving control device, 43: steering mechanism, 44: braking and driving mechanism, 45: fifth wheel, 46: lift, 51: king pin, 72: reception unit, 73: calculation unit, 74: storage unit, 75: transmission unit, 100: conveyance system, 110a: processing circuit, 110b: processor, 110c: memory, 331: position estimating unit, 332: route determining unit, 333: route following unit, 411: driving control unit, 413: peripheral situation monitoring unit, 414: GPS receiver, 415: external sensor, 416: peripheral recognizing unit, 417: vehicle state acquiring unit, 418: steering angle sensor, 419: vehicle speed sensor, 420: gyro sensor, 421: acceleration sensor, 422: communication bus, 423: in-vehicle communication unit, 424: connection control unit, 431: steering actuator, 441: braking and driving actuator

1. A conveyance system for connecting a conveyance vehicle to a trailer parked on a site of a delivery center and moving the trailer to a warehouse provided in the delivery center or a parking lot of the delivery center by the conveyance vehicle, the conveyance system comprising:
processing circuitry configured to
transmit work information indicating a number of times of conveyance of the trailer by the conveyance vehicle;
receive the work information;
store the received work information;
calculate a delivery fee on a basis of the stored work information; and
transmit fee information indicating the calculated delivery fee to a customer.

2. The conveyance system according to claim 1, wherein
the number of times of conveyance is calculated using a number of times of conveyance of the trailer from the parking lot to the warehouse by the conveyance vehicle.

3. The conveyance system according to claim 1, wherein
the number of times of conveyance is calculated using a number of times of conveyance of the trailer from the warehouse to the parking lot by the conveyance vehicle.

4. The conveyance system according to claim 1, wherein
the number of times of conveyance is calculated using a number of times obtained by adding a number of times of conveyance of the trailer from the parking lot to the warehouse by the conveyance vehicle and a number of times of conveyance of the trailer from the warehouse to the parking lot by the conveyance vehicle.

5. The conveyance system according to claim 1, wherein
the number of times of conveyance is calculated using a number of the trailers towed by the truck and entering the delivery center.

6. The conveyance system according to claim 1, wherein
the number of times of conveyance is calculated using a number of the trailers towed by the truck and exiting the delivery center.

7. The conveyance system according to claim 1, wherein
the processing circuitry calculates the delivery fee as a flat rate when the number of times of conveyance exceeds a predetermined threshold.

8. The conveyance system according to claim 1, wherein
the number of times of conveyance is calculated using sensor information acquired by a roadside sensor provided on a site of the delivery center or sensor information acquired by an in-vehicle sensor provided in the conveyance vehicle.

9. A conveyance vehicle used in the conveyance system according to claim 1, the conveyance vehicle comprising:
a second processing circuitry configured to
generate a travel plan of the conveyance vehicle included in the conveyance system, the travel plan being used to execute conveyance of the trailer from the parking lot to the warehouse or conveyance of the trailer from the warehouse to the parking lot by the conveyance vehicle; and
execute driving control on a basis of the generated travel plan.

10. A conveyance method for connecting a conveyance vehicle to a trailer parked on a site of a delivery center and moving the trailer to a warehouse provided in the delivery center or a parking lot of the delivery center by the conveyance vehicle, the conveyance method comprising:
transmitting work information indicating a number of times of conveyance of the trailer by the conveyance vehicle, and receiving the work information;
storing the received work information;
calculating a delivery fee in proportion to the stored work information; and
transmitting fee information indicating the calculated delivery fee.
